(19) United States
(12) Patent Application Publication
(10) Pub. No.: US 2019/0111745 A1
(43) Pub. Date: Apr. 18, 2019

(54) Axle Carrier of a Vehicle Having a Bearing Part for an Anti-Roll Bar

(71) Applicant: Bayerische Motoren Werke Aktiengesellschaft, Muenchen (DE)

(72) Inventor: Matthias STANGL, Dachau (DE)

(21) Appl. No.: 16/157,688

(22) Filed: Oct. 11, 2018

(30) Foreign Application Priority Data
Oct. 12, 2017 (DE) 10 2017 218 276.8

(51) Int. Cl. B60G 3/08

(52) U.S. Cl. CPC B60G 3/08; B60G 2204/4306; B60G 2204/418; B60G 2204/4302

(57) ABSTRACT

An axle carrier of a vehicle has a bearing part for an anti-roll bar. The bearing part has a bearing seat in the manner of a pipe clamp, is fastened releasably to the axle carrier, and is provided with a shaped-out formation which assumes a further function. The shaped-out formation is a lever arm which is oriented at least partially in the direction of the vehicle outer side and is designed so as to introduce a portion of the impact force into the axle carrier in the case of a vehicle impact with only a partial overlap. An additional supporting structure for reinforcement purposes for the case of an impact is provided on the bearing part, which supporting structure is fastened in a non-positive manner to a longitudinal carrier and to a crossmember of the axle carrier.

### CROSS REFERENCE TO RELATED APPLICATION

This application claims priority under 35 U.S.C. § 119 from German Patent Application No. 10 2017 218 276.8, filed Oct. 12, 2017, the entire disclosure of which is herein expressly incorporated by reference.

### BACKGROUND AND SUMMARY OF THE INVENTION

The invention relates to an axle carrier of a vehicle having a bearing part for an anti-roll bar, which bearing part has a bearing seat in the manner of a pipe clamp, is fastened releasably to the axle carrier, and is provided with a shaped-out formation which assumes a further function. In respect of the prior art, reference is made, in particular, to DE 10 2011 002 964 A1 as well as to DE 10 2012 204 032 A1.

With regard to a minimization of the risk of injury to vehicle occupants in case of an impact of the vehicle with an obstacle, so-called “crash levers” or the like are known and used (cf. document DE 10 2012 204 032 A1 mentioned above), which crash levers become active, in particular, in the case of an impact with only a partial overlap, that is to say, for example, if a bollard penetrates into the side front region of the vehicle. They can be designed, for example, so as to destroy another chassis part of the vehicle and, in particular, a wheel control vehicle part as a consequence of their crash-induced deformation or movement, or to snap it out of its anchoring. In this way, it can be avoided, for example, that the vehicle wheel, which is situated in this region, penetrates into the footwell of the vehicle.

Up to now, said crash levers are configured as independent components and therefore have to be attached suitably on already existing components of the vehicle, which results in an increased assembly effort.

Furthermore, it can be difficult for a crash lever of this type (which is generally called a shaped-out formation in the present case) to be designed in a sufficiently stable manner and/or to be fastened in the vehicle in a suitably stable manner. Here, DE 10 2011 002 964 A1 (which was mentioned at the outset) discloses a bearing part for an anti-roll bar on an axle carrier of a vehicle, which bearing part not only mounts the anti-roll bar, but can also forward forces in a targeted manner in a suitable way and/or into another suitable structural element in the case of a crash.

Returning to the briefly described problem of a sufficient support of a crash lever or the like, a solution for this is to be indicated hereby (=object of the present invention).

This object is achieved by way of an axle carrier of a vehicle having a bearing part for an anti-roll bar, which bearing part has a bearing seat in the manner of a pipe clamp, is fastened releasably to the axle carrier, and is provided with a shaped-out formation which assumes a further function. The shaped-out formation is a lever arm which is oriented at least partially in the direction of the vehicle outer side and is designed so as to introduce a portion of the impact force into the axle carrier in the case of a vehicle impact with only a partial overlap.

The invention is distinguished by the fact that the shaped-out formation is a lever arm which is oriented at least partially in the direction of the vehicle outer side and is designed so as to introduce a portion of the impact force into the axle carrier in the case of a vehicle impact with only a partial overlap. Advantageous embodiments and developments are further described herein.

Bearing parts or bearing seats for the anti-roll bars in double track vehicles are known in different embodiments. They originally served solely for mounting the anti-roll bar and, in the process, supplemented or supplement a lower shell which is provided or machined, for example, in an axle carrier in the manner of a bracket-shaped pipe clamp or in the form of a semicircular upper shell to form a complete bearing carrying structure of an anti-roll bar bearing. As described, it is also known that a further structure (called a shaped-out formation here) which assumes a further function can be integrally formed on a bearing part of this type. In the present case, a shaped-out formation of this type is then to act or at least to be capable of acting in a way which protects the vehicle occupants, in a similar manner to a crash lever.

Here, a shaped-out formation according to the invention in the form of a lever arm which is used in the case of a vehicle impact with only a partial overlap (or offset), by either an obstacle, which strikes the vehicle, striking said lever arm (or said shaped-out formation) directly or by a vehicle part which is moved by way of an obstacle of this type striking said lever arm (or said shaped-out formation), is first of all designed so as to, as it were, stop said obstacle or the vehicle part which is moved by way of it. The obstacle or the vehicle part which is moved by way of it is therefore first of all to be stopped from penetrating further rearward in the vehicle structure. Depending on the magnitude of the impact, the shaped-out formation (=“lever arm”) which is provided according to the invention can be deformed as long as it can be supported sufficiently on the axle carrier.

Here, the lever arm according to the invention can possibly even snap the axle carrier partially out of its fastening on the vehicle undertray. If the latter occurs, this is an impact which is so severe that any type of energy dissipation is to be welcomed. In particular, however, the axle carrier and, with it, the wheel control links which are fastened to it can then be moved in such a way that the wheel which is situated in said impact region is deflected in such a way that it cannot penetrate into the footwell of the driver or front passenger. The result is that the vehicle occupants are protected in an optimum manner in this regard at any rate.

As an alternative or in addition to the preceding description, a lever arm which is provided according to the invention or a shaped-out formation of this type can also act, however, like the crash lever which is described in DE 10 2012 204 032 A1 (which was mentioned at the outset), and, in the case of a crash, can destroy an articulated connection of a wheel control link, for example directly, or can destroy another wheel control element in a suitable manner, in order to protect the vehicle occupants against additional injuries, in particular by way of a wheel of the vehicle, which wheel penetrates into their footwell. Regardless of the behavior of a lever arm which is oriented according to the invention and is provided on the bearing part (of an anti-roll bar), said lever arm can at any rate be assembled extremely simply together with the bearing part, and can be designed in a geometrically optimum manner with regard to its function.

In the context of one advantageous development, an additional supporting structure for reinforcement purposes for the case of an impact can be provided on the bearing part, which supporting structure is fastened in a non-positive manner to a longitudinal carrier and to a crossmember of the axle carrier. This results in an optimum introduction of force into the axle carrier, since a connecting point is not unnecessarily incorporated or interposed here between the longitudinal carrier and the crossmember (of the axle carrier); rather, the load support takes place as desired directly both on the longitudinal carrier which faces the impact side and on the (front, as viewed in the vehicle driving direction) crossmember of the axle carrier. For the further reinforcement of the assembly which is produced in this way, the abovementioned additional supporting structure can also have a section which engages around the anti-roll bar in the manner of a pipe clamp.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is an isometric illustration of an axle carrier with a bearing part according an exemplary embodiment of the invention, in which the axle carrier is only partially illustrated in an abstract manner.

FIG. 2 is a top plan view of the bearing part according to FIG. 1, in an installed state in a vehicle.

FIG. 3 is a side view of the bearing part in the installed state in a vehicle transverse direction.

### DETAILED DESCRIPTION OF THE DRAWINGS

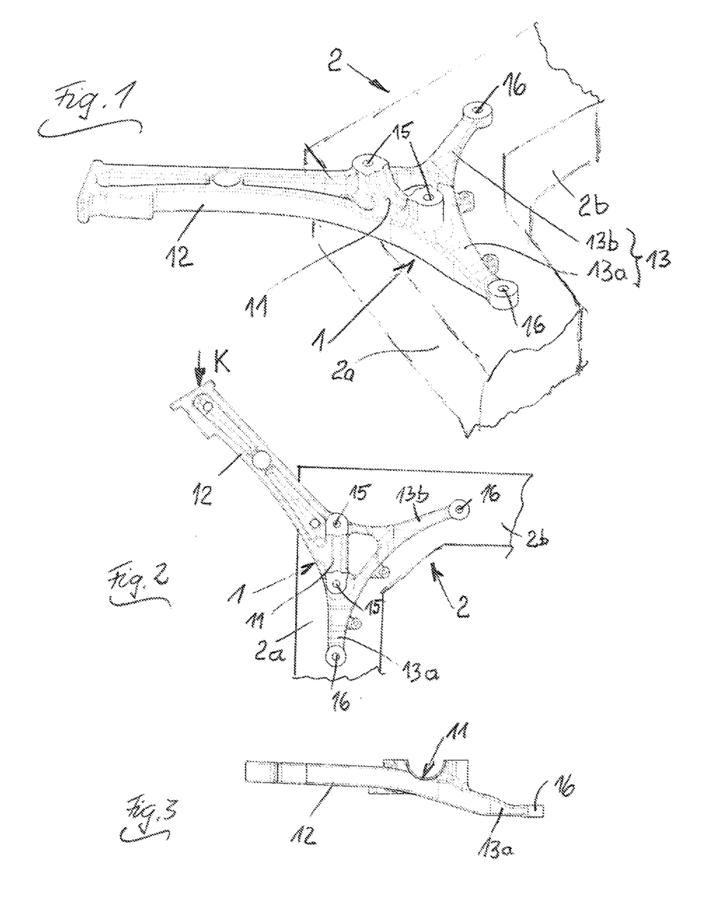

One exemplary embodiment is shown in the figures. Here, FIG. 1 shows an axle carrier (which is illustrated merely in a fragmented and greatly abstracted manner) having a bearing part according to the invention, in an isometric illustration, which bearing part is shown in a plan view (looking onto the roadway as viewed in the vehicle vertical axis direction) in FIG. 2 (in the installed state with the simplified axle carrier) and in a side view in FIG. 3 (as viewed in the vehicle transverse direction in the installed state). As far as the installed state is concerned as shown, the bearing part is fastened to the axle carrier in a vehicle in its left-hand front region.

The designation 2 denotes a frame-like and approximately rectangular axle carrier which is provided on the front axle of a double track vehicle, in particular a passenger motor vehicle, and is constructed from two longitudinal carriers 2a, of which only the left-hand one as viewed in the vehicle driving direction is shown here in a greatly abstracted manner, and two crossmembers 2b, of which only the front one as viewed in the vehicle driving direction is shown here in a greatly abstracted manner. The respective longitudinal carriers 2a are connected to the respective crossmembers 2b as customary, for example via cast nodes (not shown here). An anti-roll bar (not shown) is also mounted on the axle carrier 2. For this purpose, a pipe clamp-like bearing seat 11 is provided on a bearing part 1 which is denoted overall by the designation 1, is contiguous per se, and is produced in a casting process, for example. A short section of the anti-roll bar (not shown) which runs horizontally from left to right in the illustration of FIG. 2 lies in the semicircular-cylindrical bearing seat 11 of the bearing part 1. The bearing seat 11 is screwed releasably to the axle carrier 2 together with the bearing part 1 via screws (not shown) which are guided through receiving bores 15 in the bearing part 1, which bores 15 are provided on the two sides of the bearing seat 11 (on its semicircular shape in the manner of tangents).

A further essential constituent part of the bearing part 1 is a lever arm 12 which is designed, in the case of a vehicle impact with only a partial overlap, so as to absorb a portion of the impact and introduce it into the axle carrier 2. For this purpose, the bearing part 1 is connected releasably to the axle carrier 2 via further releasable screw connections. The lever arm 12 extends, as it were, starting from the bearing seat 11 of the bearing part 1, outward and forward at an angle of approximately 45° with respect to the driving direction of the vehicle. In order to then support the lever arm 12 as satisfactorily as possible on the bearing part 1 for the case where a high force K, which is directed substantially counter to the driving direction of the vehicle, acts on its free end in an accident-induced manner, a suitable supporting structure 13 is configured on the bearing part 1. The supporting structure 13 is designed in the form of two arms 13a, 13b which, in a manner which adjoins the lever arm 12 and the bearing seat 11 and at an angle of in each case approximately 120° with respect to the lever arm 12, extend rearward and inward toward the vehicle center plane in directions which are approximately opposed to one another. Further receiving bores 16 for fastening screws are provided in the end regions of the arms 13a, 13b, via which receiving bores 16 the bearing part 1 is fastened to the axle carrier 2. The arm 13a which is oriented approximately counter to the vehicle driving direction is supported in a non-positive manner on the longitudinal carrier 2a, and the arm 13b which is oriented approximately in the vehicle transverse direction (toward the vehicle center) is supported in a non-positive manner on the crossmember 2b.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An axle carrier of a vehicle, comprising:
a bearing part for an anti-roll bar, wherein
the bearing part has a bearing seat formed as a pipe clamp,
the bearing part is fastened releasably to the axle carrier,
the bearing part is provided with a shaped-out formation having an additional function,
the shaped-out formation is a lever arm oriented at least partially in a direction of an outer side of the vehicle, and
the lever arm is configured so as to introduce a portion of an impact force into the axle carrier in an event of a vehicle collision with only a partial overlap.

2. The axle carrier as claimed in claim 1, wherein
the bearing part comprises an additional supporting structure for reinforcement in the event of the vehicle collision, and
the additional supporting structure is fastened in a non-positive manner to a longitudinal carrier and to a crossmember of the axle carrier.

3. The axle carrier as claimed in claim 2, wherein
the additional supporting structure also comprises a section engaging around the anti-roll bar in a pipe clamp manner.
